(19) United States
(12) Patent Application Publication
(10) Pub. No.: US 2026/0024554 A1
(43) Pub. Date: Jan. 22, 2026

(54) AUTOMATIC GENERATION OF CLIPS OF CAPTURED VIDEO OF AN EVENT

(71) Applicant: KlutchShots, Inc., Castle Pines, CO (US)

(72) Inventors: Jeffrey Brent Snyder, Castle Pines, CO (US); Sajjad Sarkoobi, North Vancouver (CA)

(21) Appl. No.: 19/270,469

(22) Filed: Jul. 15, 2025

Related U.S. Application Data
(60) Provisional application No. 63/671,992, filed on Jul. 16, 2024.

(51) Int. Cl. G11B 27/031; G06T 7/11; G06T 7/20; G06V 20/40

(52) U.S. Cl. CPC G11B 27/031; G06T 7/11; G06T 7/20; G06V 20/41; G06T 2207/10016; G06T 2207/20132

(57) ABSTRACT

A device obtains video of an event captured by an image capture device and detects one or more objects within frames of the video. Tracking data for detected objects across frames of the video is also generated for detected objects. Based on the tracking data, the device generates a graph representing detections of objects in different frames and selects an optimal path traversing the graph. The device selects a set of key frames based on nodes along the optimal path and applies one or more reframing methods to the set of key frames to generate a clip comprising a subset of the video. The clip may be distributed to user devices or to a backend server for distribution.

### CROSS-REFERENCE TO RELATED APPLICATIONS

This application claims the benefit of U.S. Provisional Application No. 63/671,992 filed on Jul. 16, 2024, which is incorporated by reference herein in its entirety.

### BACKGROUND

Increasingly, people record videos of various events for subsequent playback. For example, people record video of sporting events to watch at a later time or to share with other people. As an example, parents record video of sporting events in which their children participate to share with other family members or with friends. As another example, an athlete records a sporting event for subsequently reviewing or analyzing techniques or strategies employed during the sporting event.

Often, specific portions of an event, rather than the complete event, are relevant to one or more people. For example, a person recording video of a sporting event is interested in performance of a specific participant (e.g., a family member or a friend participating in the sporting event) in the sporting event rather than the sporting event in its entirety. Conventionally, a person manually reviews and edits video to identify and to extract specific clips of the video relevant to the person. This may involve significant human time and resources.

### BRIEF DESCRIPTION OF THE DRAWINGS

Figure (FIG. 1 is a block diagram of an example embodiment of a computing environment in which a clip generation application operates.

FIG. 2 is a block diagram of an example embodiment of a clip generation application.

FIG. 3 is an example graph representing detections of objects in different frames of video.

FIG. 4 is a flowchart of an example process for automatically generating a reframed highlight clip.

FIG. 5 is an example of object detection in a frame of video.

FIG. 6 is an example interface presenting frames of video for manual selection of key frames to generate a clip of the video.

FIG. 7 is an example clip generated from video.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. Wherever practicable, similar or like reference numbers may be used in the figures and may indicate similar or like functionality.

A device and application automatically generates clips of interest of an event (such as a sporting event) from captured video. Relative to the initially captured video, the clips of interest may be temporally limited to a segment of the video and/or may be limited spatially to a cropped portion of the video. The cropped video may be reframed relative to the original aspect ratio of the captured video (e.g., transforming from a landscape aspect ratio to a portrait aspect ratio). The clip of interest may smoothly track an object of interest (such as a player, ball, vehicle, or other object), may intelligently transition between tracked objects of interest (e.g., switching from tracking a player to a ball), and/or may switch between different perspectives captured from different video sources, thereby creating a professional-looking highlight clip that can be quickly shared (e.g., via social media, text message, or other sharing platform).

In one implementation, a device obtains video of an event captured by an image capture device. The device applies one or more detection models to the video to detect objects within frames of the video. In various embodiments, the device applies one or more detection models that are specific to a type of event captured in the video. For example, different models or sets of models may be applied for basketball events, volleyball events, baseball events, etc. Each detection model is trained to detect one or more specific objects (e.g., player, ball, goal, net, field/court, etc.) within video in some embodiments. The detection models may be of sufficiently limited complexity to enable devices with limited computing resources (e.g., mobile device or other local processing device) to locally apply one or more detection models and rapidly obtain object detection results (e.g., within a few seconds) without necessarily relying on cloud-based processing. The one or more detection models also generate tracking data that tracks locations of objects across different frames, thereby providing information about movement of one or more detected objects between different frames.

Based on the tracking data and various selection criteria, the device selects an optimal sequence of object detections for the video that selects between which detected object is optimal to follow over one or more segments. This selection may result in selecting to follow the same object throughout a video clip or to transition between objects at selected instances. For example, in basketball, the system may initially follow a player with the ball and then track the ball during a shot. In another case, the system may follow the ball as it is passed between different players. In another example, the system may initially track an off-ball player. Furthermore, the selection may result in transitioning between different time-synchronized videos of the event.

In some embodiments, the device generates a graph representing detections of one or more objects in each of a set of frames and selects the optimal path through the graph that determines which object will be the center of focus (which may change between segments) in generating the highlight clip. A node in the graph corresponds to an object detection within a frame of the video, so detection of multiple objects in a frame results in multiple nodes being generated for the same frame, each corresponding to a different object detected in the frame. Each node is associated with a score providing a predicted measure of interest in the frame and object corresponding to a node. The graph includes edges that connect between all pairs of nodes corresponding to subsequent frames with an edge having a head at a node corresponding to an earlier frame and a tail at a node corresponding to a later frame. Each edge is associated with a weight representing a cost of transitioning from the node at the head of the edge to the node at the tail of the edge. The cost may incorporate various factors reflecting the desirability of transitioning from the node at the head of the edge to the node at the tail of the edge.

The device generates a path score for multiple paths through the graph, with the path score for a path based on a combination of scores of nodes along the path decreased by a combination of weights of edges connecting nodes along the path in some embodiments. Alternatively, the path score comprises a sum of weights of edges connecting nodes along the path, depending on how weights of edges are calculated. In various embodiments, the device selects a path having a path score satisfying one or more criteria (e.g., having a maximum path score, having a minimum path score). The selected path identifies, in each frame, an object of interest to track in the highlight clip (which may comprise the same object across the clip or may selectively transition between focal objects at certain transition points dictated by the optimal path).

The device selects a set of key frames from the video and applies one or more reframing methods to the set of key frames to generate a clip of the video. In various embodiments, the device leverages scores of nodes in the graph representation to choose key frames. For example, the device initially selects a key frame that corresponds to the node having the highest node score. The device then selects additional frames in the forward and backwards time direction from the initial key frame that meet certain selection criteria. For example, the additional key frames may be selected at fixed time intervals based on dynamically selected time intervals dependent on the motion parameters of the object of interest (e.g., a faster moving object may lead to key frames that are closer together).

The video is cropped at each key frame to achieve a desired zoom and aspect ratio of the output video and to substantially center the chosen object of interest at each key frame. The zoom level may be user-configured or automatically configured (e.g., using a rule-based or machine learning model-based approach). The crop region of each key frame includes at least one focus object in the key frame. Further, the crop region may differ in different key frames. For example, in one key frame, a crop region including a focus object may appear at the upper right region of the original video, while in another key frame, a crop region including the focus object may appear at a lower left region of the original video. Application of one or more reframing processes may interpolate reframing between key frames such that the location and/or zoom of the crop region of a key frame smoothly transitions between different key frames, thereby appearing to track the focus object over various frames. A video clip of the video may then be encoded based on the reframing process (i.e., as a sequence of frames corresponding to the respectively selected crop regions of each of the original video frames). The clip may be distributed to user devices or to a backend server for distribution.

FIG. 1 illustrates an example embodiment of a computing environment 100. The computing environment 100 includes one or more processing devices 110 executing a clip generation application 115, one or more user devices 140 executing a clip generation application 115, a network 120, a backend server 130, and one or more capture devices 150. In different embodiments, the computing environment 100 may include different or additional components than those described in conjunction with FIG. 1. For example, in some embodiments, the computing environment may include the user devices 140 and exclude the processing device 110 and capture device 150. Alternatively, the computing environment may include the processing device 110 and capture devices 150 and does not necessarily include user devices 140. Further, in some embodiments, the computing environment 100 includes components that combine functionality of multiple components depicted in FIG. 1.

The user device 140 generally operates to capture video and enable user interactions via a user interface such as requesting highlight clips, selecting parameters associated with highlight generation, viewing highlights, sharing highlights, etc. Different types of user devices 140 may be included in the computing environment 100. Examples of a user devices 140 include a mobile phone, a tablet computer, a laptop computer, a wearable device (e.g., a smartwatch), or other type of computing device. Additionally, a user device 140 can include an image capture device configured to capture video (e.g., either an attached camera, a standalone camera, or a camera integrated with a computing device).

The processing device 110 may comprise any computing device such as a laptop computer, desktop computer, server box, or custom processing device, or any other device capable of executing the clip generation application 115 described herein. The processing device 110 may be coupled to one or more capture devices 150 (e.g., cameras) for capturing video. In some embodiments, the processing device 110 may have greater computing and/or storage capabilities than a typical user device 140, although this is not necessarily the case. The processing device 110 may operate locally relative to the capture devices 150 and/or user devices 140 (e.g., coupled via a local area network). In further embodiments, the processing device 110 could be implemented remotely via an enterprise server or using cloud infrastructure.

A clip generation application 115 can execute on a user device 140, a processing device 110, or both to perform the video processing associated with clip generation. In some implementations, the user devices 140 primarily operate as user interface devices that facilitate video capture and enable user interactions such as requesting highlights, capturing clips, editing clips, specifying parameters, initiating video sharing, viewing videos, etc. Rather than directly generating the highlight clips, the user devices 140 in some embodiments may transmit captured video to the processing device 110 to perform the highlight generation. The processing device 110 may then send the generated clips back to the user devices 140. The processing device 110 may also operate based on video captured from one or more dedicated capture devices 150.

In other environments, the user devices 140 may directly perform video processing to generate highlight clips without relying on a separate processing device 110. For example, a user device 140 may capture video using an integrated camera (or obtain video from another user device 140 or capture device 150), directly generate a highlight clip via the clip generation application 115, and present the highlight clip via a user interface.

In further environments, both user devices 140 and a dedicated processing device 110 may execute respective clip generation applications 115 in coordination. For example, video captured by one or more user devices 140 and video obtained from one or more capture devices 150 may be collected and time synchronized to enable generating highlights derived from multiple different capture sources. Such coordination may be performed on a user device 140, on the processing device 110, by the backend server 130, or by a combination thereof.

The clip generation application 115 (executing on either the processing device 110, a user device 140, or both) generates one or more clips of the video. A clip comprises a subset of the video corresponding to a limited time interval of the video and/or spatially cropped portion of the video (which may be reframed to a different aspect ratio than the original video). Multiple clips corresponding to different time intervals may be generated from captured video or may be derived from multiple videos.

In some embodiments, an image capture device 150 and/or user device 140 continuously records video of an event. The user can review the video to select time intervals for generating highlights according to the process described herein. Additionally, the user can select to generate a clip during a live event (e.g., by pressing a highlight button) to cause generation of a clip from some prior time interval of video (e.g., the last 15 seconds, 20 seconds, etc.) Alternatively, to conserve storage space, while the image capture device 150 or user device 140 continuously records video, a buffered time interval is stored and subsequently overwritten (e.g., last 20 seconds). In response to receiving a request to generate a clip, the clip generation application 115 retrieves a subset of the stored video within a specific duration of a time when the request was received. For example, in response to receiving a request to generate the clip, the clip generation application 115 retrieves a subset of stored video from one or more video sources corresponding to a specific duration of 10 seconds before a time when the request was received.

In another embodiment, the clip generation application 115 automatically selects a time interval of interest for generating a video highlight. Such time intervals may be selected using one or more rule-based approaches or using a machine learning model trained to detect characteristics of video segments indicative of a highlight of interest. Such models may be specific to the type of sport (e.g., scoring a basket in basketball).

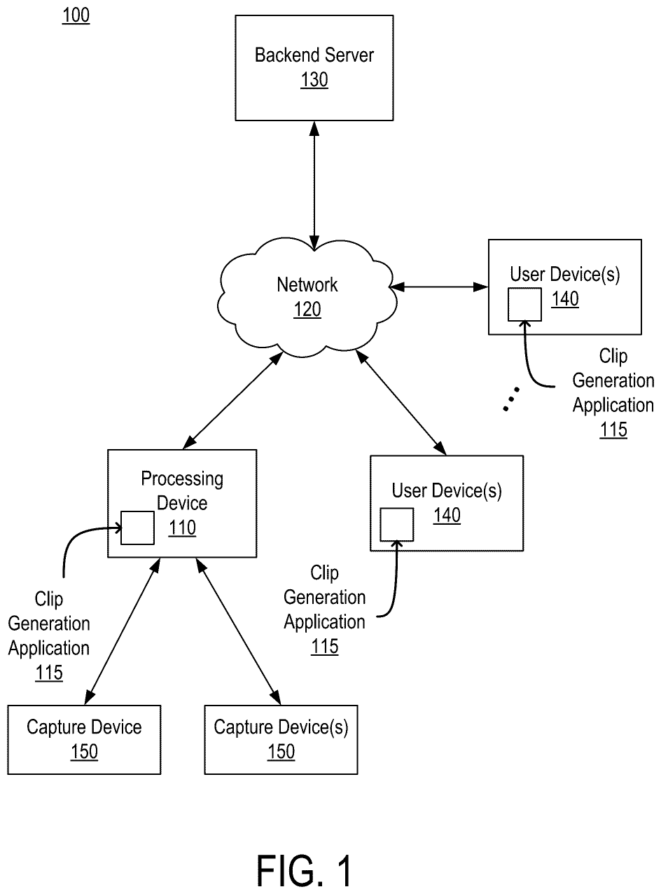

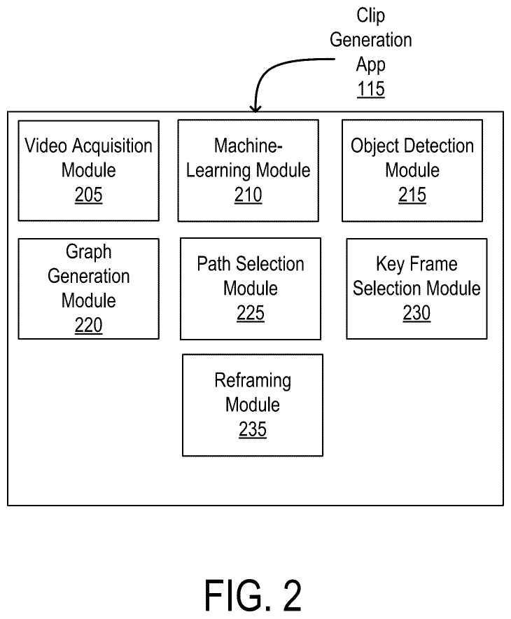

The clip generation application 115 applies one or more object detection models to video. As further described below in conjunction with FIG. 2, different object detection models may be trained for different events (and/or specific types of objects) to detect objects within frames of video data. In some embodiments, the clip generation application 115 selects a specific object detection model (or set of models) to apply to the video based on type of event identified (e.g., by a user or automatically inferred by an event detection model). The object detection models may be locally stored on the processing device 110 and/or user device 140 or may be retrieved from the backend server 130 and applied by the clip generation application 115 in various embodiments.

In addition to detecting one or more objects in the video data, the clip generation application 115 generates tracking data for detected objects across frames of the video data. For example, the clip generation application 115 detects a ball in a frame of the video data and identifies the ball in subsequent frames, with tracking data identifying positions of the ball in different frames. In another example, an object comprises a playing field, a playing surface, or another region where an event occurs. Tracking data is generated for each detected object in the video to enable subsequent identification and location of different objects in the video. The clip generation application 115 may locally apply the object detection models without necessarily requiring cloud-based processing.

The captured video may include multiple objects that are detected and tracked within the obtained video, of which different objects may have different levels of relevance to a user. For example, the clip generation application 115 detects and tracks multiple people in the obtained video, while a user is interested in a specific person in the obtained video. Similarly, the clip generation application 115 may detect different balls in the video, while a specific ball in the video is of interest to the user.

In various embodiments, data from the clip generation application 115 may be used to train or to retrain one or more object detection models. For example, a user of the clip generation application 115 may identify whether an object was correctly detected within video by the clip generation application 115. The user's identification may be stored in association with a portion of captured video and with information identifying detection of the object by the clip generation application 115. The labeled result of detecting the object may be used as a training example to modify one or more parameters of a detection model, as further described below.

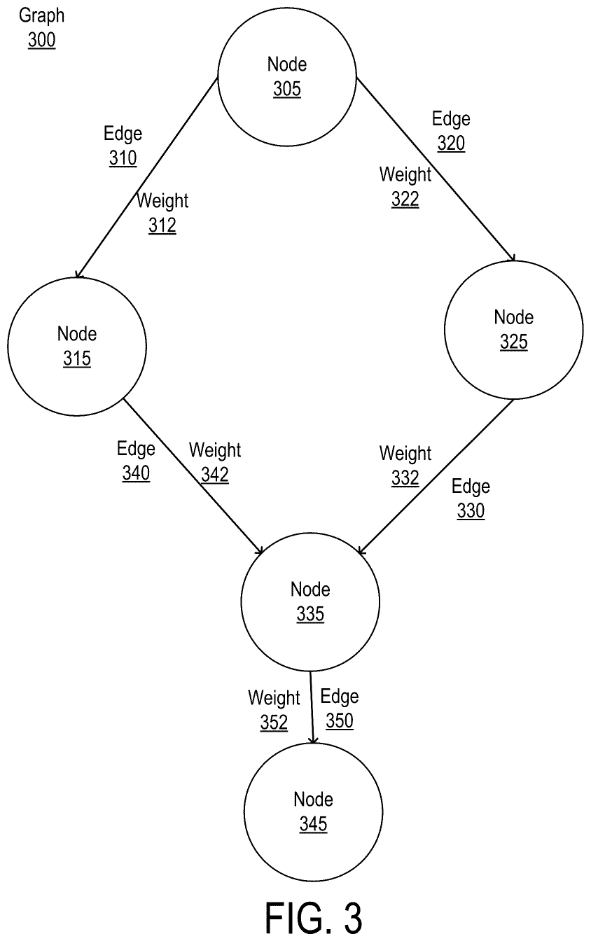

To efficiently generate one or more clips of the video relevant to a user, the clip generation application 115 generates a graph representation of detection of objects in one or more videos. As further described below in conjunction with FIGS. 2 and 3, each node in the graph represents a detection of an object in a frame of the video. Edges connect nodes corresponding to detections of objects in consecutive frames. An edge between a pair of nodes has a direction, with the edge having a head at an originating node and a tail at a termination node. The head of an edge is at a node corresponding to a frame occurring at an earlier time than a frame corresponding to the tail of an edge. As a node represents detection of an object in the video, multiple nodes may correspond to a frame of the video when the clip generation application 115 detected multiple different objects in the frame.

Each node has a set of attributes including a score indicating a measure of predicted interest or relevance of the detected object corresponding to the node based on a set of predefined scoring criteria, as further described below in conjunction with FIGS. 2 and 3. Similarly, each edge connecting a pair of nodes has a weight, with the weight of an edge based on negative features (i.e., a cost) from transitioning from a node connected to the head of the edge to another node connected to the tail of the edge. Based on scores for nodes and weights of edges connecting pairs of nodes, the clip generation application 115 selects an optimal path through the graph, with the optimal path comprising a sequence of objects detected in frames of the video corresponding to nodes along the optimal path. For example, the clip generation application 115 generates path scores for a plurality of possible paths from an origin node in the graph to an ending node in the graph and selects the optimal path based on the path scores. In various embodiments, a path score for a path is based on a difference between a sum of scores of nodes in the path and a sum of edges connecting the nodes in the path, while in other embodiments, a path score for a path is based on a sum of weights of edges between nodes along the path, as further described below in conjunction with FIG. 2. In various embodiments, the optimal path represents a focus object or sequence of objects to be tracked in the reframed highlight clip. The optimal path selection may be configured to select focus objects having the highest likelihood of being of interest to the user based on the detected objects in the video and features of one or more frames of the video.

The original video may depict the focal objects associated with the optimal path from varying viewpoints in different frames. For example, certain frames of the optimal sequence have a focus object partially obscured, while other frames of the sequence have the focus object more clearly visible. As another example, certain frames of the optimal sequence have a focus object in different positions with the frames. Furthermore, the optimal path through the graph may include nodes corresponding to detections of different objects in different frames.

In a further embodiment, the clip generation application 115 may obtain video and/or object detection information captured from multiple user devices 140 or other capture devices 150 at the same event. The clip generation application 115 may then generate a highlight clip that combines video from two or more different user devices 140 or other capture devices 150. Here, the graph-based implementation described above may be utilized to switch between object detections originating from different videos. For these transitions, the output highlight clip may cut between frames from different original videos captured from different devices.

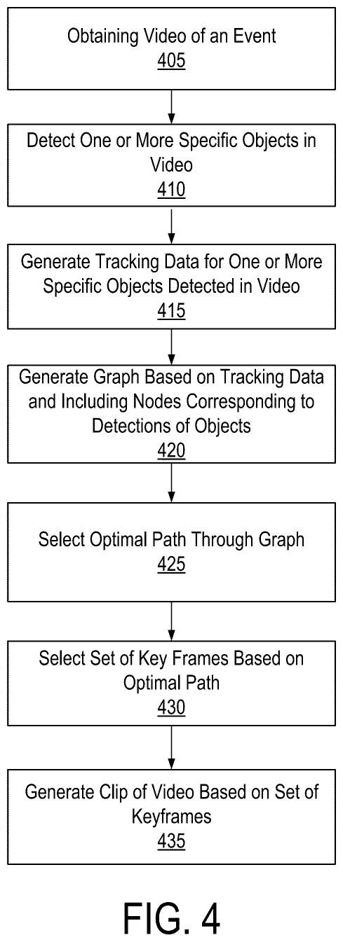

For the output clip to prominently present (e.g., at appropriate zoom level) and center one or more focus objects in the reframed video, the clip generation application 115 reframes and crops video around the focal objects based on a reframing process. In one example reframing process, the clip generation application 115 first selects a set of key frames. In various embodiments, the clip generation application 115 selects one or more key frames automatically using the scores of nodes associated with different frames of the sequence, as further described below in conjunction with FIGS. 2 and 4. In various embodiments, the set of key frames comprises a subset of the sequence of frames, so the set of key frames includes less than the complete sequence of frames.

The clip generation application 115 determines a crop region for each key frame that centers or otherwise prominently positions and zooms to the focus object. A crop region may have specific horizontal and vertical dimensions to define a specific portion of a key frame spatially proximate to a focus object included in the crop region. In some embodiments, attributes of a focus object (e.g., dimensions of the focus object in a key frame, a type of the focus object), determine dimensions of a crop region, allowing different zoom levels of the crop regions to be used for different focus objects and areas. For example, a smaller (i.e., zoomed in) crop region is used for an object occupying a smaller area of a frame (e.g., a ball), while a larger (i.e., zoomed out) crop region is used for an object occupying a larger area of a frame (e.g., a goal, a playing surface). Similarly, a zoom level of a crop region may vary depending on a size of an object included in the crop region. These zoom levels may be user-selected, rule-based, or intelligently generated using machine learning techniques.

A reframing process interpolates position and zoom level of the crop region including a focus object in the frames between adjacent key frames so the clip includes smooth transitions of the position of the crop region. The reframing process may also optionally overlay additional information over frames of the clip. Example additional information includes statistics and information relevant to the clip, identifying information of one or more objects (e.g., people) in frames of the clip, or other information that augments content in frames of the clip.

In some embodiments, the clip generation application 115 receives manual selection or editing of one or more key frames from the obtained video. For example, rather than automating selection of key frames as further described above, the clip generation application 115 presents the video to a user, and the user selects individual frames of the video as key frames. When manually selecting key frames, the user selects a focus object of a key frame and specifies one or more parameters of a key frame. For example, the user crops a frame so the key frame includes a region of the frame around a focus object or changes a zoom level of the key frame.

In other implementations, the clip generation application 115 first automatically recommends key frames and respective crop regions within the key frames, but presents an interface that enables a user to modify the set of key frames generated by the clip generation application 115. For example, the clip generation application 115 displays the captured video with the automatically selected key frames and recommended crop regions identified. For example, the clip generation application 115 selects the set of key frames and visually distinguishes the selected key frames from other frames together with visually depicting parameters of the crop region for the key frame (e.g., cropping of the key frame around an object, a zoom level of the key frame, an aspect ratio of a key frame, etc.). The clip generation application 115 receives one or more inputs from a user to select or modify the key frames and/or the parameters (e.g., position and zoom of the crop region) of one or more key frames selected by the clip generation application 115. The user may remove one or more key frames selected by the clip generation application 115 and manually select alternative key frames in some embodiments. Hence, the user may adjust which frames are selected as key frames and the corresponding crop regions to be utilized in the final output clip in various embodiments, enabling customization of the key frames.

In various embodiments, the clip generation application 115 facilitates sharing of the generated clip of video between user devices 140 or via various sharing mechanisms (e.g., text, social media, etc.).

The clip generation application 115 may furthermore generate highlight clips from different video sources and may identify clips corresponding to the same event and same times. The clip generation application 115 may then store and/or combine (e.g., stitch) highlight clips together to create reels including the same highlight from multiple perspectives. In a further embodiment, the clip generation application 115 may generate combined highlight clips from multiple videos from different video sources (e.g., user devices 140 and/or capture devices 150).

The network 120 comprises communication pathways for communication between one or more user devices 140, the processing device 110, and the backend server 130. In some embodiments, the capture devices 150 may also couple to the processing device 110 via the network 120. The network 120 may include one or more local area networks and/or one or more wide area networks (including the Internet) including cloud-based network architectures. The network 120 may also include one or more direct wired or wireless connections (e.g., Ethernet, WiFi, cellular protocols, WiFi direct, Bluetooth, Universal Serial Bus (USB), or other communication link). In some embodiments, the processing device 110, capture devices 150, and one or more user devices 140 may operate locally on a local area network while the backend server 130 may be implemented via a cloud-based architecture. Alternatively, one or more functions of the processing device 110 could execute remotely or via cloud infrastructure.

The backend server 130 may be implemented as one or more traditional physical servers and/or one or more virtual machines. The backend server 130 may comprise one or more on-site or remote processing and/or storage devices. For example, in a cloud-based implementation, the backend server 130 may include multiple distributed computing and storage devices managed by a cloud service provider. The backend server 130 may include an aggregation of multiple servers responsible for different functions and may include various physical or virtual servers managed and/or operated by different entities. In various implementations, the backend server 130 may comprise one or more processors and one or more non-transitory computer-readable storage mediums that store instructions executable by the one or more processors for carrying out the functions attributed to the backend server 130 herein.

The backend server 130 maintains one or more machine-learning models for distributing to the clip generation application 115. The machine learning models may be trained in an offline process (e.g., using various cloud-based training services or local processing systems) based on a set of training examples. The detection models may be available on the backend server 130 for distribution to the clip generation application 115 in some embodiments.

The backend server 130 may also coordinate between user devices 140 and/or the processing device 110 to automatically initiate and/or share highlight clips for multiple user devices 140. For example, if a highlight clip is requested on a user device 140, it may communicate the request to the backend server 130, which may identify other user devices 140 at the same location capable of generating highlight clips for the same timeframe (e.g., from video that may be locally buffered). The highlight clips can then be shared between the different user devices 140.

FIG. 2 is a block diagram of an example embodiment of a clip generation application 115. In the example shown by FIG. 2, the clip generation application 115 includes a video acquisition module 205, a machine-learning module 210, an object detection module 215, a graph generation module 220, a path selection module 225, a key frame selection module 230, and a reframing module 235. In various embodiments, the clip generation application 115 may include different, additional, or fewer components than those described in conjunction with FIG. 2.

The video acquisition module 205 acquires images or video of an environment. Video may be acquired from a user device 140 or from a video capture device 150 coupled to or integrated with the processing device 110.

The machine-learning module 210 obtains and stores one or more machine-learning models for local execution (for example, object detection models). In various embodiments, the machine-learning module 210 obtains and maintains multiple sets of detection models. Different sets of detection models may be associated with different types of events. The training may include training a detection model that can concurrently detect multiple different types of objects associated with an event (e.g., a ball, player, goal, court area, etc.).

The machine learning models may be trained in an offline process (e.g., using various cloud-based training services or local processors) based on a set of training examples. Each training example includes input data to which the detection model is applied to generate an output. For example, a training example includes video annotated to identify a specific object or set of objects within the video. Training examples may include video of one or more objects captured from different positions relative to the one or more objects, providing different angles of an object to train a detection model. In these cases, a detection model is trained by comparing its output when receiving a training example as input to a label for the training example. For example, a location of a frame in a training example predicted as including an object by a detection model is compared to a location of the frame in the training example labeled as including the object. In general, during training with labeled data, the set of parameters of the detection model may be set or adjusted to reduce a difference between the output for the training example (given the current parameters of the model) and the label for the training example.

Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, multi-modal large language models and any models developed in the future.

The object detection module 215 applies one or more detection models maintained by the machine-learning module 210 to the acquired video. Different detection models may be obtained for different types of events (e.g., one or more models associated with each different sport). The object detection module 215 may receive a selection of a type of event from a user or may automatically detect the event type. The object detection module 215 subsequently applies the one or more detection models for the event type to the acquired video. A detection model may operate to concurrently detect multiple different objects in the video frames. The detection models may be applied locally at the processing device 110 or user device 140 without relying on cloud-based processing.

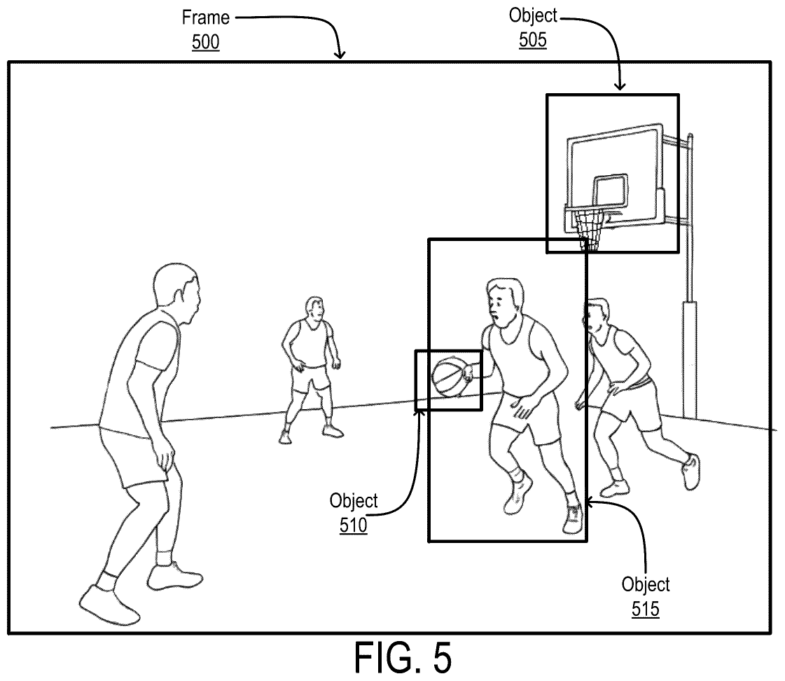

Applying detection models to video obtained identifies one or more objects in frames of the video and locations of the one or more objects within frames of the video. Hence, the object detection module 215 both detects one or more objects in video and tracks one or more detected objects through different frames of video based on locations of an object in different frames. In various embodiments, the object detection module 215 outputs locations and sizes (e.g., coordinates) of bounding boxes surrounding a detected object in the frames and object identifiers identifying the detected objects. An example visual representation of the operation of the object detection module 215 is illustrated below in conjunction with FIG. 5.

Tracking of objects may include tracking across non-consecutive frames. For example, a detected object may become occluded or out of view of the camera and may be re-detected in subsequent frames. The object detection module 215 may identify when detected objects correspond to a previously tracked object and assign the same object identifier to the subsequent detections.

Based on detections of one or more objects and locations of each detected object in various frames of the video, the graph generation module 220 generates a graph representing detected objects in various frames of the video over time. The graph generation module 220 generates a node in the graph for each detection of an object in a frame. Each node in the graph corresponds to a combination of a frame of the video and an object detected in the frame. Multiple nodes may be generated for a single frame, with different nodes from the frame corresponding to different objects detected in the frame. In some embodiments, multiple time-synchronized clips of an event from different cameras may be obtained and processed together in this manner. Here, the set of nodes may include object detections across all videos. Multiple nodes may be generated for the same timestamp for object detections in the same video or corresponding to the same timestamp across different videos.

In various embodiments, the graph generation module 220 module may filter the object detections based on various criteria and generate nodes for only a subset of object detections. For example, the graph generation module 220 generates one or more features for detected objects. The graph generation module 220 generates a score based on features of the object or other features of the frame. The graph generation module 220 generates nodes for object detections having scores satisfying one or more criteria (e.g., meeting a minimum threshold score) while omitting other detections. Other criteria that are not necessarily score-based may be used by the graph generation module 220 to filter objects. For example, the filtering may exclude objects in certain regions of the frame or non-moving objects. As another example, nodes may be excluded when an object is not within a threshold distance of another object in frames. In another example, nodes may be excluded when an object is within a threshold distance of another object in frames. Different criteria may be maintained for different objects or for different combinations of objects in various embodiments. The graph may exclude nodes corresponding to frames of the video in which no object was detected in various embodiments.

The graph generation module 220 also associates attributes with each node. An attribute of a node comprises a node identifier uniquely identifying the node. Other attributes of a node include a name of the node, an identifier of an object corresponding to the node, and an identifier of a frame of video corresponding to the node, or an identifier of the video from which the node originated. The attribute may include a tracking identifier for the associated object that is consistent across nodes corresponding to the same tracked object. Additionally, an attribute of a node comprises a score providing a predicted measure of interest of a detected object corresponding to the node to a user. In various embodiments, the graph generation module 220 determines a score for a node based on features of one or more objects detected in a frame corresponding to the node.

The graph generation module 220 maintains a set of rules for determining a score of a node in various embodiments. Each rule may generate a sub-score for the node and the sub-scores may be combined to generate the overall score (e.g., as a weighted combination). For example, a score for a node is increased if the object corresponding to the node is within a threshold distance of another object in the frame corresponding to the node. As another example, a score for the node is increased in response to an object corresponding to the node being in a foreground of the frame corresponding to the node. Other rules may specify different criteria for one or more features of an object corresponding to a node for determining the score of the node. Alternatively, the graph generation module 220 applies a trained scoring model to a frame corresponding to the node, and the scoring model determines a score for the node based on features of an object corresponding to the node in a frame corresponding to the node. The graph generation module 220 generates a score for each node corresponding to a detection of an object in a frame of video.

The graph generation module 220 also generates edges connecting different pairs of nodes. In various embodiments, an edge connects nodes corresponding to consecutive frames. An edge has a direction from a source node having an earlier time to a destination node having a later time, so edges depict progression between different frames of the video. Hence, the graph includes edges connecting nodes corresponding to detections of objects in different frames of the video. Furthermore, for graphs generated from multiple videos, the edges may connect between nodes from different videos corresponding to consecutive timestamps (e.g., between an object detection node at time t in one video and an object detection node at time t+1 in another video).

In some embodiments, edges may be generated between nodes in which a tracked object last appears and nodes in which new tracked objects first appear, even if the frames are not temporally consecutive. This allows the graph to track and represent objects across frames that may or may not have breaks in the tracking (e.g., due to occlusions or other tracking artifacts).

Additionally, the graph generation module 220 also generates a weight for each edge connecting an originating node and a terminating node. A weight of an edge provides a measure of a cost from reaching the terminating node from the originating node that negatively reflects desirability of the transition. In various embodiments, the cost of an edge has an opposite sign than a score of a node. For example, a score of a node is negative, while a cost of an edge is positive. As another example, a score of a node is positive, while a cost of an edge is negative. In various embodiments, the graph generation module 220 determines a weight for an edge based on changes in features of an object in an originating frame corresponding to the originating node and features of the object in a terminating frame corresponding to the terminating node. For example, greater changes between locations of the object in the originating frame and the location of object in the terminating frame increase a magnitude of a weight of an edge connecting an originating node for the originating frame and a terminating node for the terminating frame. As another example, the cost of an edge may increase in magnitude for nodes having different tracking identifiers (i.e., nodes correspond to different objects or different originating videos) relative to nodes having the same tracking identifiers (i.e., nodes correspond to the same object in the same original video). Similarly, an object corresponding to an originating node being in a foreground of an originating frame corresponding to the originating node and being in a background of a terminating frame corresponding to a terminating node increases a magnitude of a weight of an edge connecting the originating node to the terminating node. Conversely, an object corresponding to an originating node being in a background of an originating frame corresponding to the originating node and being in a foreground of a terminating frame corresponding to a terminating node decreases a magnitude of a weight of an edge connecting the originating node to the terminating node.

The graph generation module 220 maintains a set of rules for determining a weight of an edge connecting an originating node to a terminating node based on features of an originating frame corresponding to the originating node and features of a terminating frame corresponding to the terminating node in various embodiments. Various rules increase or decrease a magnitude of an edge connecting the originating node to the terminating node if satisfied by the originating frame or by the terminating frame in various embodiments. In other embodiments, the graph generation module 220 maintains an edge scoring model that receives an originating frame for an originating node and a terminating frame for a terminating node as input. Based on features in the originating frame and in the terminating frame, the graph generation module 220 generates a score for an edge connecting the originating node to the terminating node. An example graph is further described below in conjunction with FIG. 3 for purposes of illustration.

In some embodiments, a weight of an edge between an originating node and a terminating node comprises a difference between a score for the terminating node and a cost of transitioning from the originating frame for the originating node to the terminating frame for the terminating node. The graph generation module 220 stores the determined difference as the weight for an edge connecting the source node to the destination node. In such embodiments, the weight of an edge between the source node and the destination node accounts for the scores of the nodes and the cost of transitioning from the source node to the destination node. However, in other embodiments, the graph generation module 220 stores a cost of traversing the graph from the source node to the destination node as the weight of an edge connecting the source node to the destination node.

In some embodiments, when determining scores for nodes or weights for edges, the graph generation module 220 generates multiple different sets of features for each frame. Different sets of features may result in different scores for nodes and weights for edges. The graph generation module 220 may receive one or more preferences of a user for generating a clip and select a set of features associated with the one or more preferences. Subsequently the graph generation module 220 determines scores for nodes and weights for edges based on the selected set of features, so the scores and weights reflect one or more preferences of the user. Further, the graph generation module 220 may alternatively or additionally select a set of parameters based on prior interactions by users with the clip generation application 115. For example, manual modifications to key frames by a user may affect which set of parameters the graph generation module 220 uses to generate scores and weights for nodes and edges, respectively, of the graph so the scores and weights more accurately reflect preferences of the user for content in a clip of the video.

Based on the graph connecting detections of objects in frames, the path selection module 225 selects an optimal path through the graph. In some embodiments, the path selection module 225 uses scores of nodes in the graph and weights of edges connecting nodes in the graph to select the optimal path through the graph. In other embodiments, the path selection module uses weights of edges connecting nodes in the graph to select the optimal path through the graph. The optimal path includes one or more focus objects that are associated with the nodes along the optimal path. Different focus objects may be included in the optimal path (i.e., the path may switch between objects).

In various embodiments, the path selection module 225 determines an optimal path from an origin node of the graph to an ending node of the graph satisfying one or more criteria. In some embodiments, the path selection module 225 creates the origin node as a dummy node corresponding to a time earlier than a time of a node corresponding to a frame when an object was initially detected in the video. Similarly, the path selection module 225 adds the ending node as a dummy node corresponding to a time later than one or more nodes corresponding to a frame including a final detection of an object in the video. The origin node is connected to each node corresponding to a frame in which one or more objects were first detected in the video, while the ending node is connected to each node corresponding to a frame in which one or more objects were last detected in the video. The origin node and the ending node each have a score of zero. Edges connecting the origin node to other nodes have weights of zero, while edges connecting nodes to the ending node also have weights of zero.

In various embodiments, the path selection module 225 generates a path score for each of the possible paths between the origin node to the ending node. In some embodiments, the path selection module 225 generates the path score for a path by combining a score of nodes included in the path into an aggregated node score and offsets the aggregated node score by an aggregated edge weight determined by combining weights of edges between nodes comprising the path. For example, the path selection module 225 sums scores of each node included in the path to generate the aggregated node score and sums weights of edges between nodes included in the path to generate the aggregated edge weight. In the preceding example, the path selection module 225 subtracts the aggregated edge weight from the aggregated node score to generate the path score for the path. Alternatively, in embodiments where a weight of an edge between an originating node and a terminating node comprises a difference between a score for the terminating node and a cost of transitioning from the originating frame for the originating node to the terminating frame for the terminating node, the path selection module 225 generates a path score for a path by combining (e.g., summing) weights of edges between nodes included in the path.

The path selection module 225 selects a path having a path score satisfying one or more criteria as the optimal path. For example, the path selection module 225 selects a path having a minimum path score in embodiments where the scores of nodes are negative and the weights of edges are positive as the optimal path. However, in embodiments where the scores of nodes are positive and the weights of edges are negative, the path selection module 225 selects a path having a maximum path score as the optimal path.

In various embodiments, the path selection module 225 applies a path selection process to the graph to select the optimal path through the graph. For example, the path selection module 225 applies a Bellman-Ford process to the graph to select the optimal path through the graph based on the scores of nodes and weights of edges between nodes. However, in other embodiments, the path selection module 225 applies an alternative path selection process to the graph to select the optimal path through the graph based on the scores of nodes and weights of edges between nodes.

The key frame selection module 230 selects key frames as anchor points for the reframing process. In various embodiments, the key frame selection module 230 leverages attributes of nodes along the optimal path to automatically select one or more frames as key frames. For example, the key frame selection module 230 initially selects a frame associated with a node in the optimal path through the graph having a maximum score as an initial key frame. However, in other embodiments, the key frame selection module 230 uses different criteria to select the initial key frame.

From the initial key frame, the key frame selection module 230 traverses the video frames until one or more selection criteria are satisfied. Subsequently, the key frame selection module 230 selects the frame where the one or more selection criteria are satisfied as another key frame. The key frame selection module 230 iteratively traverses through additional frames from a selected key frame until reaching another frame satisfying the one or more selection criteria relative to the previously selected key frame, and continues iteratively (in both directions from the initial key frame) until the start and end of the video is reached.

Different selection criteria may be specified in different embodiments. For example, a stopping criterion comprises an object in a prior key frame being outside the crop region that will be applied in the prior selected key frame. As another example, a stopping criterion comprises a threshold number of frames passing from a prior key frame. In an additional example, a stopping criterion comprises an object having a position in a frame having at least a threshold distance from a position of the object in a prior key frame. As another example, a stopping criterion comprises a rate of change in a location of an object from a key frame to another frame equaling or exceeding a threshold. Additional or alternative stopping criterion may be applied by the key frame selection module 230 in various embodiments.

In embodiments using the key frame selection module 230, the set of key frames comprises a subset of the optimal sequence of frames. Alternatively, the key frame selection module 230 may be omitted. In this case, the crop region may be directly set based on the object location in every frame individually (as opposed to only setting in key frames).

The reframing module 235 generates a clip of the video by applying one or more reframing processes to the set of key frames. A reframing process sets framing of a key frame based on one or more focus objects in the key frame. For example, a reframing process determines a crop region of a key frame that includes a focus object and a region of the key frame around the focus object, while removing portions of the key frame outside of the crop region. The clip includes the crop regions identified from different key frames, so the clip more prominently displays one or more focus objects corresponding to each crop region. Similarly, a zoom level of the crop region may be modified based on the focus object included in the crop region, so a key frame more prominently displays the one or more focus objects relative to frames of the obtained video. The dimensions of a crop region and zoom level of a crop region may be based on dimensions of one or more objects included in the crop region in various embodiments. In various embodiments, reframing parameters such as position of object in the reframed region, zoom level, or other parameters may be selected based on user inputs or may be automatically chosen using rule-based or machine learning techniques.

In some embodiments, a reframing process interpolates movement of one or more crop regions between adjacent key frames so crop regions smoothly transition between consecutive key frames in the generated clip. In various embodiments, the reframing process interpolates movement of the crop region between key frames and generates one or more intermediate frames that move the crop region from a location in a key frame to a location in a subsequent key frame. A reframing process may also smooth transitions between locations of the crop region in consecutive key frames through application of one or more filters in various embodiments. Such a reframing process results in a clip where the crop region smoothly transitions from location to location in different key frames. In the case that every frame is used as a key frame, the interpolation step may be omitted.

In various embodiments, the reframing module 235 may also modify other various parameters of the output clip. For example, the reframing module 235 may determine a target resolution for the clip and modify resolutions of frames to match the target resolution. Hence, the reframing module 235 may increase or decrease a resolution of one or more frames based on the target resolution. Additionally, the reframing module 235 determines an aspect ratio of frames of the clip and modifies frames to have the determined aspect ratio. For example, the reframing module 235 modifies frames to have an aspect ratio of 9:16; however, in other embodiments, the reframing module 235 modifies key frames to have an alternative aspect ratio. The reframing module 235 may store a target aspect ratio received from a user and modify aspect ratios of frames of the set to the target aspect ratio in various embodiments.

Applying the one or more reframing processes to the set of frames generates a clip of the video including frames focused on the one or more focus objects and smoothly follows the object (or intelligently transitions between objects). This process may also involve switching between videos. As described above, this may result in a highlight clip associated with a single video or derived from multiple videos.

The key frame selection module 230 and reframing module 235 may alternatively allow a user of the user device 140 to manually select one or more key frames via a user interface. For example, the key frame selection module 230 presents the frames to a user and receives a selection of one or more frames from the user together with the desired crop region. The key frame selection module 230 and stores the selected frames as the set of key frames.

In other embodiments, the key frame selection module 230 automatically selects the set of key frames and crop regions, and subsequently enables manual customization. For example, the key frame selection module 230 presents a representation of the video with recommended key frames and crop regions that are visually distinguished in the interface. Subsequently, the key frame selection module 230 may receive one or more selections from the user to modify one or more key frames and/or crop regions of the set.

The reframing module 235 transmits the generated clip to the backend server 130 for storage in various embodiments. In various embodiments, the reframing module 235 transmits the generated clip, an identifier of a user who requested generation of the clip, and one or more other attributes of the clip to the backend server 130. The backend server 130 stores the clip in association with the attributes received in conjunction with the clip to simplify subsequent retrieval of the clip by users of the backend server 130.

FIG. 3 illustrates an example of a graph 300 representing detection of objects in frames of video data, as further described above in conjunction with FIG. 2. The graph 300 includes a plurality of nodes and edges connecting nodes to other nodes. As further described above in conjunction with FIG. 2, each node corresponds to a frame of video and an object detected in the frame of video. Different nodes correspond to different objects, so multiple nodes may be associated with a common frame of video and different objects detected within the frame. Furthermore, nodes can be derived from multiple videos and may be time-aligned such that nodes from different videos corresponding to the same frame time correspond to the same time index in the graph.

In the example of FIG. 3, node 305 corresponds to a first object detected in a frame. For example, node 305 corresponds to a person detected in the frame of video. In the example of FIG. 3, a single object is detected in the frame of video, so the graph 300 includes a single node, node 305, for the frame of video. As further described above in conjunction with FIG. 2, node 305 is associated with multiple attributes. An attribute of node 305 may comprise a score of node 305, which provides a measure of relevance of the object detected in the frame corresponding to node 305 to a user. Other attributes of a node include an identifier of the node, an identifier or a frame of video corresponding to the node, or other information.

In the example of FIG. 3, node 315 corresponds to the detection of the first object in a second frame of video that is subsequent to the frame. Node 315 has various attributes, including a score of node 315 and information identifying the second frame and uniquely identifying node 315.

Edge 310 connects node 305, corresponding to detection of the first object in the frame, to node 315, corresponding to detection of the first object in the second frame. Hence, edges connect nodes corresponding to frames at different times of the video, such as consecutive frames. Edge 310 has a direction originating from node 305 and ending at node 315. Additionally, edge 310 is associated with weight 312 that represents a cost of transitioning from the node 305 to node 315. The cost of transitioning from a node to an additional node provides a measure of a change in visibility, change in detectability of the object, or other factors negatively impacting desirability of the transition. In various embodiments, weight 312 comprises the score of node 315 reduced by a cost of transitioning from node 305 to node 315.

In the example of FIG. 3, a second object (different from the first object) is detected in the second frame, and node 325 corresponds to detection of the second object in the second frame. Various attributes are associated with node 325, including a score of node 325 and information identifying the second frame and uniquely identifying node 325.

As the second frame is later than the first frame, edge 320 connects node 305 to node 325. Edge 320 has a direction originating from node 305 and ending at node 325. Directionality of edge 320 indicates that the second frame occurs later than the first frame. Additionally, edge 320 is associated with weight 322 which represents a cost of transitioning from the frame corresponding to node 305 to the second frame corresponding to node 325. In various embodiments, weight 322 comprises the score of node 325 reduced by a cost of transitioning from node 305 to node 315.

Because node 305 corresponds to detection of a first object, while node 325 corresponds to detection of the second object, weight 322 has a greater magnitude than weight 312 in various embodiments. Weight 322 having a higher magnitude than weight 312 reflects node 305 and node 325 corresponding to different objects, with the transition between different objects in connected nodes indicating an increased cost to transitioning between the different nodes. For example, node 305 corresponds to detection of a person in the frame, while node 325 corresponds to detection of a goal in the second frame. Having different nodes correspond to detection of different objects increases a magnitude of the weight of an edge between the different nodes relative to an edge connecting different nodes corresponding to detection of a common object, with the increased weight representing an increased cost from the change in objects between the nodes.

In the example of FIG. 3, node 335 corresponds to detection of the first object in a third frame of video. The third frame is subsequent to the second frame, so nodes corresponding to the second frame have edges connecting them to node 335. For example, node 305 corresponds to the person detected in the frame of video corresponding to node 305. Node 335 is associated with multiple attributes including a score of node 335, an identifier of node 335, and an identifier of the third frame corresponding to node 335.

Edge 330 connects node 325 (corresponding to the second frame) to node 335, while edge 340 connects node 315 (corresponding to the second frame) to node 335. Weight 332 is associated with edge 330 and represents a cost from transitioning from detection of the second object in the second frame, corresponding to node 325, to detection of the first object in the third frame, corresponding to node 335. In various embodiments, weight 332 comprises the score of node 335 reduced by a cost of transitioning from node 315 to node 335. Similarly, weight 332 is associated with edge 330 and represents a cost from transitioning from detection of the second object in the second frame, corresponding to node 325, to detection of the first object in the third frame, corresponding to node 335. In various embodiments, weight 332 comprises the score of node 335 reduced by a cost of transitioning from node 325 to node 335. In various embodiments, weight 342 is less than weight 332, as node 315 and node 335 both correspond to detection of the first object, while node 325 and node 335 correspond to detection of the second object and detection of the first object, respectively. As further described above, changes in the object corresponding to different nodes increases a magnitude of the weight of an edge connecting the different nodes.

Node 345 corresponds to detection of the first object in a fourth frame, of the video that is subsequent to the third frame. Node 345 is associated with multiple attributes including a score of node 345, an identifier of node 345, and an identifier of the fourth frame corresponding to node 345. Edge 350 connects node 335 to node 345, with edge 350 originating at node 335 and ending at node 345. Weight 352 is associated with edge 350 to represent a cost of transitioning from the detection of the first object in the third frame corresponding to node 335 to the detection of the first object in the fourth frame corresponding to node 345. In various embodiments, weight 352 comprises the score of node 345 reduced by a cost of transitioning from node 335 to node 345.

As further described above in conjunction with FIG. 2, the clip generation application 115 selects an optimal path through the graph 300 based on the weights (as well as the scores of nodes in various embodiments). As further described above in conjunction with FIG. 2, the clip generation application generates a path score for each of a set of paths through the graph 300 based on weights of edges connecting pairs of nodes along a path (and based on scores of nodes along the path in some embodiments) from a starting node to an ending node of the graph. The weights of edges have an opposite sign as scores of nodes, so scores of nodes along a path are decreased by weights of edges connecting the nodes along the path.

In the example, of FIG. 3, the clip generation application 115 identifies a first path score for a first path from node 305 to node 315 to node 335 to node 345. In some embodiments, the first path score comprises a sum of weight 312, weight 342, and weight 352. Alternatively, the clip generation application 115 generates a first aggregated node score for the first path by summing scores associated with each of node 305, node 315, node 335, and node 345. The clip generation application 115 also generates a first aggregated edge weight for the first path by summing weight 312, weight 342, and weight 352. The first path score comprises a difference between the first aggregated node score and the first aggregated edge weight. The clip generation application 115 also identifies a second path from node 305 to node 325 to node 335 to node 345.

In some embodiments, the clip generation application 115 generates a second path score for the second path by summing weight 322, weight 332, and weight 352. Alternatively, the clip generation application 115 generates a second aggregated node score for the second path by summing scores associated with each of node 305, node 325, node 335, and node 345. The clip generation application 115 also generates a second aggregated edge weight for the first path by summing weight 322, weight 332, and weight 352. The second path score comprises a difference between the second aggregated node score and the second aggregated edge weight. In the example of FIG. 3, weight 312 is less than weight 322, while weight 342 is greater than weight 332. Hence, in the example of FIG. 3, the first path score has a greater magnitude than the second path score, so the optimal sequence of frames comprises frames corresponding to each node along the first path.

FIG. 4 is a flowchart of an example process for automatically generating a clip comprising a subset of captured video of an event. As further described above, a clip generation application 115 obtains 405 video of an event (e.g., from a user device 104 or other image capture device 150). The segment of video may be user-selected in some embodiments. In another embodiment, a machine learning model may automatically identify a segment of video that contains a highlight for reframing. In further embodiments, the obtained video may include video from multiple captured capture devices corresponding to the same time period.

Through application of one or more detection models, the clip generation application 115 detects 410 one or more objects in frames of the video and generates 415 tracking data of each of the one or more objects in the video. In various embodiments, the tracking data comprises an identifier of each detected object and a location of each detected object in different frames of the video. In various embodiments, the clip generation application 115 retrieves a detection model associated with a particular sport for performing the object detection. Tracking may include re-identifying the same object in subsequent frames after tracking lost (e.g., when an object becomes occluded or leaves the field of view of the camera and object re-enters video.

Based on the tracking data of the one or more objects, the clip generation application 115 generates 420 a graph representing the video. As further described above in conjunction with FIGS. 2 and 3, the graph includes a node corresponding to detections of objects in frames of the video based on the tracking data. Edges connect nodes corresponding to consecutive frames. Hence, each node corresponds to a combination of a frame and an object detected in the frame. Each node has a score providing a measure of relevance of the object corresponding to the node to a user, and each edge has a weight indicating a cost from the video transitioning between frames corresponding to nodes connected by the edge, as further described above in conjunction with FIG. 2.

Based on the graph, the clip generation application 115 selects 425 an optimal sequence of object detections (i.e., optimal path through graph) for rendering as focal regional in the output video. In various embodiments, the clip generation application 115 generates a path score for different paths between an origin node of the graph and ending node of the graph based on scores of nodes along the path and weights of edges connecting the nodes comprising the path. Scores of nodes and weights of edges have opposite signs in various embodiments. For example, scores are negative values, while weights are positive values. In various embodiments, the clip generation application 115 identifies the optimal path as a path having a path score satisfying one or more criteria. In embodiments where scores of nodes are negative values and weights of edges are positive values, the clip generation application 115 selects the optimal path as a path having a minimum path score. The optimal path represents one or more focus objects, where each focus object corresponds to a node along the optimal path (e.g., maximum path score).

Based on the optimal sequence of frames, the clip generation application 115 selects 430 a set of key frames. The clip generation application 115 leverages the graph generated from the video to select 430 the set of key frames in various embodiments. For example, the clip generation application 115 selects 430 an initial key frame as a frame corresponding to a node with a maximum score. The clip generation application 115 traverses additional frames forward and backward in time from the initially selected key frame until reaching a node corresponding to a frame satisfying one or more selection criteria, as further described above in conjunction with FIG. 2. The node satisfying the one or more selection criteria is also selected 430 as a key frame, and the clip generation application 115 iteratively traverses the frames to select 430 additional key frames as frames satisfying one or more selection criteria. In various embodiments, the set of key frames includes a subset of frames. Each key frame is associated with a crop region around the object of interest. Alternatively, the step 430 may be omitted, and crop regions may be set directly in each frame (thus every frame effectively acts as a key frame).

Based on the set of key frames, the clip generation application 115 generates 435 a clip of the video. In various embodiments, the clip generation application 115 applies one or more reframing processes to the original video to generate 435 the clip based on the set of key frames and the one or more reframing processes.

The reframing process interpolates movement and/or zoom of crop region between adjacent key frames so the crop region smoothly transitions between consecutive key frames in the generated clip. Similarly, a reframing process smooths transitions between the position of focus object in consecutive key frames through application of one or more filters in various embodiments. A reframing process may also modify a resolution of the key frames, modify an aspect ratio of the key frames, or modify one or more other parameters of the key frames to generate 435 the clip.

The clip generation application 115 stores the generated clip for subsequent retrieval by a user. In some embodiments, the clip generation application 115 transmits the clip to a backend server 130 or may directly share clips via other applications.

FIG. 5 illustrates an example of object detection in a frame of video. The frame 500 of video shown in the example of FIG. 5 includes a bounding box corresponding to object 505, a bounding box corresponding to object 510, and a bounding box corresponding to object 515. The objects are each associated with respective object identifiers.

In one embodiment, the clip generation application 115 applies a detection model that is specific to the type of event (e.g., basketball, volleyball, etc.) and is specifically trained to detect certain objects of relevance to that event. Thus, different detection models may be used for different events. In the example of FIG. 5, a single detection model may operate to detect each of the objects 505, 510, 515 concurrently. The clip generation application 115 may also run multiple models in sequence with a first model running and then a second model running after the first model and utilizing output from the first model pass. In an alternative embodiment, the clip generation application 115 may apply different detection models to the frame 500 to detect each different type of object 505, object 510, and object 515.

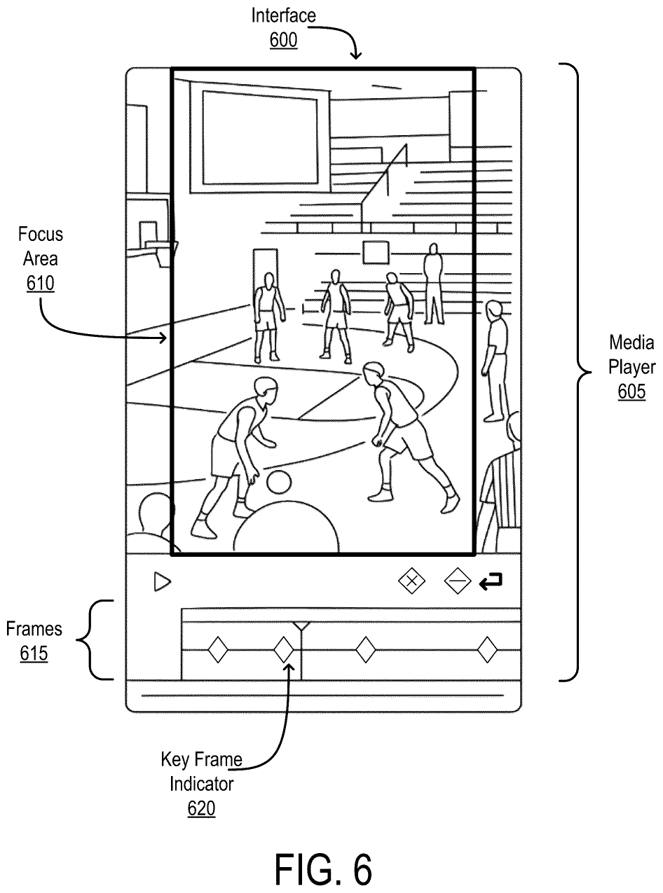

FIG. 6 illustrates an example interface presenting frames of video for manual selection of key frames for generating a clip of the video. In various embodiments, the user device 140 presents the interface 600 to a user after selecting an optimal path (objects to follow) and recommending a set of key frames, as further described above in conjunction with FIGS. 1, 2, and 4. The interface 600 includes a media player 605 that renders frames of the video. Additionally, the interface 600 visually indicates a focus area 610 of a frame rendered by the media player 605 representing an initially selected crop region. For example, the focus area 610 has one or more different visual characteristics than portions of the frame outside of the focus area 610. In the example of FIG. 6, portions of the frame outside of the focus area 610 are grayed out or presented with a reduced brightness relative to the focus area 610 to visually differentiate the focus area 610 from other portions of the frame in the media player 605.

Additionally, the interface 600 presents a timeline of the sequence of frames 615. In the timeline, individual frames of the are temporally displayed from a first frame to a last frame. Hence, the timeline chronologically displays different frames, enabling identification and review of individual frames.

Further, a key frame indicator 620 is displayed on the timeline in conjunction with frames selected as key frames. In the example of FIG. 6, the key frame indicator 620 is an icon or a symbol overlaid on frames selected as key frames. A user may interact with the timeline to modify selected key frames. For example, an interaction with a frame via the timeline selects the frame as a key frame, while an alternative interaction with the frame via the timeline removes the frame from the set of key frames. Hence, a user may manually select key frames for the set of key frames or remove key frames from the set of key frames through interaction with the interface 600. The user may also manually reposition or re-zoom the crop region is the respective key frames, which can automatically add a key frame to the timeline and save the positioning.

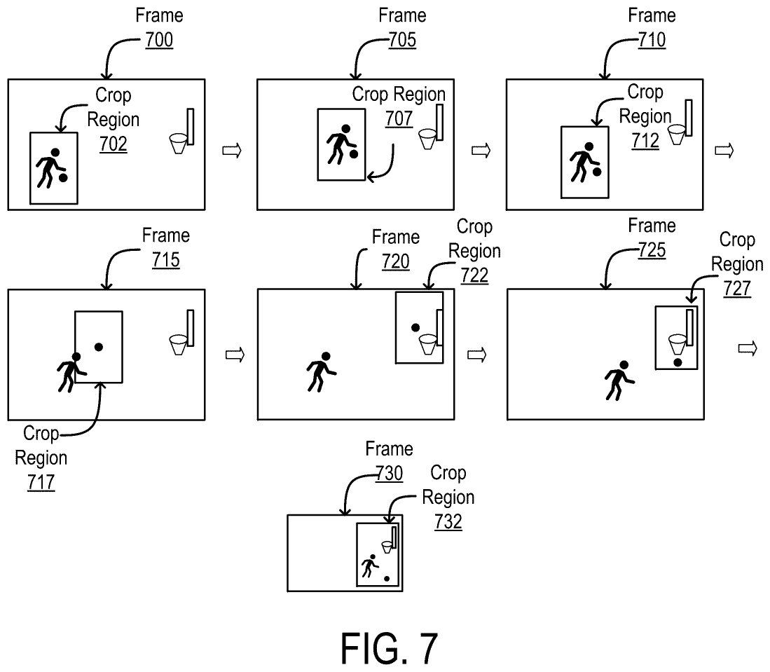

FIG. 7 illustrates an example clip generated from video based on the clip generation process described herein. Here, a set of originally captured frames 700, 705, 710, 715, 720, 725, 730 are shown together with respective crop regions 702, 707, 712, 717, 722, 727, 732 selected according to the automated process described above. The crop regions 702, 707, 712, 717, 722, 727, 732 can then be encoded as an output video clip having a different aspect ratio than the original video and which track objects of interest throughout the clip. In this example, the process initially selects a player with the ball as the focal point. Between frames 710 and 715, the focal object switches to the ball (e.g., as the player takes shot). Between frames 725 and 730, the focal object switches to a court view that is zoomed out relative to the other frames. The transitions between focusing on the player, to the ball, to the court are a result of the optimal path selection using the graph-based approach described above. The encoded output clip can then be directly stored or shared via the clip generation application 115.

The figures and the description relate to embodiments by way of illustration only. Alternative embodiments of the structures and the methods disclosed herein will be readily recognized as viable alternatives that may be employed without departing from the principles of the embodiments.

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information. These operations, while described functionally, computationally, or logically, are understood to be implemented by computer programs or equivalent electrical circuits, microcode, or the like. Furthermore, it has also proven convenient at times to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. Embodiments may also relate to an apparatus for performing the operations herein. This apparatus may be specially constructed for the required purposes, and/or it may include a general-purpose computing device selectively activated or reconfigured by a computer program stored in the computer. Such a computer program may be stored in a tangible non-transitory computer readable storage medium or any type of media suitable for storing electronic instructions and coupled to a computer system bus. Furthermore, any computing systems referred to in the specification may include a single processor or may be architectures employing multiple processor designs for increased computing capability.

Upon reading this disclosure, those of skill in the art will still appreciate additional alternative structural and functional designs for the disclosed embodiments from the principles herein. Thus, while particular embodiments and applications have been illustrated and described, the disclosed embodiments are not limited to the precise construction and components disclosed herein. Various modifications, changes, and variations, which will be apparent to those skilled in the art, may be made in the arrangement, operation, and details of the disclosed embodiments herein without departing from the scope.

Finally, the language used in the specification has been principally selected for readability and instructional purposes, and it may not have been selected to delineate or circumscribe the inventive subject matter. It is therefore intended that the scope is not limited by this detailed description, but rather by any claims that issue on an application based hereon. Accordingly, the disclosure of the embodiments is intended to be illustrative, but not limiting, of the scope of the invention, which is set forth in the following claims.

What is claimed is:

1. A method for automatically generating a video clip from obtained video, the method comprising:
obtaining video of an event from an image capture device;
generating tracking data for one or more objects detected in frames of the video through application of one or more detection models to the video, the one or more detection models detecting one or more objects in the video;
generating a graph based on the tracking data, the graph comprising nodes each corresponding to detection of an object in a frame of the video and edges connecting pairs of nodes;
selecting an optimal path through the graph based at least in part on weights associated with weights of edges in the graph;
selecting a set of key frames and crop regions for the set of key frames based on the optimal path; and
generating the clip of the video by applying one or more reframing processes to the video based on the crop regions for the set of key frames.

2. The method of claim 1, wherein selecting the optimal path through the graph based at least in part on weights associated with weights of edges in the graph comprises:
selecting an optimal path from a starting node of the graph to an ending node of the graph.

3. The method of claim 2, wherein each node is associated with a score and each edge is associated with a weight, and selecting the optimal path from the starting node of the graph to the ending node of the graph comprises:
for each of a plurality of paths from the starting node to the ending node, generating a path score by combining scores of nodes along a path of the plurality and weights of edges connecting nodes along the path of the plurality; and
selecting the optimal path based on the path scores.

4. The method of claim 3, wherein each score has a negative value and each weight has a positive value, and selecting the optimal path based on the path scores comprises:
selecting a path having a minimum path score.

5. The method of claim 3, wherein a weight of an edge connecting an originating node to a terminating node comprises a difference between a score of the terminating node and a cost of transitioning from the originating node to the terminating node.

6. The method of claim 1, wherein selecting the set of key frames based on the optimal path comprises:
identifying a node in the optimal path having a maximum score; and
selecting a frame corresponding to the identified node as an initial key frame for the set of key frames.

7. The method of claim 6, wherein selecting the set of key frames based on the optimal path comprises:
traversing the optimal path from the identified node corresponding to the initial key frame to an additional node corresponding to a frame satisfying one or more selection criteria; and
selecting the frame satisfying the one or more selection criteria for the set of key frames.

8. The method of claim 1, wherein obtaining video of an event from an image capture device comprises:
continuously recording video of the event from the image capture device;
storing a time interval of the recorded video to a storage device;
receiving a request to generate the clip; and
retrieving a subset of the video within a specific duration of a time when the request was received.

9. The method of claim 8, wherein obtaining video of an event from an image capture device further comprises:
overwriting the time interval of the recorded video stored by the storage device with subsequently recorded video.

10. The method of claim 1, wherein obtaining video of an event from an image capture device comprises:
continuously recording video of the event from the image capture device;
storing a time interval of the recorded video to a storage device;
receiving a request to generate the clip;
retrieving a subset of the video within a specific duration of a time when the request was received; and
retrieving video captured by one or more additional image capture devices captured within the specific duration of the time when the request was received.

11. A non-transitory computer readable storage medium storing instructions for automatically generating a video clip from obtained video, the instructions, when executed by one or more processors cause the one or more processors to perform steps comprising:
obtaining video of an event from an image capture device;
generating tracking data for one or more objects detected in frames of the video through application of one or more detection models to the video, the one or more detection models detecting one or more objects in the video;
generating a graph based on the tracking data, the graph comprising nodes each corresponding to detection of an object in a frame of the video and edges connecting pairs of nodes;
selecting an optimal path through the graph based at least in part on weights associated with weights of edges in the graph;
selecting a set of key frames and crop regions for the set of key frames based on the optimal path; and
generating the clip of the video by applying one or more reframing processes to the video based on the crop regions for the set of key frames.

12. The non-transitory computer readable storage medium of claim 11, wherein selecting the optimal path through the graph based at least in part on weights associated with weights of edges in the graph comprises:
selecting an optimal path from a starting node of the graph to an ending node of the graph.

13. The non-transitory computer readable storage medium of claim 12, wherein each node is associated with a score and each edge is associated with a weight, and selecting the optimal path from the starting node of the graph to the ending node of the graph comprises:
for each of a plurality of paths from the starting node to the ending node, generating a path score by combining scores of nodes along a path of the plurality and weights of edges connecting nodes along the path of the plurality; and
selecting the optimal path based on the path scores.

14. The non-transitory computer readable storage medium of claim 13, wherein each score has a negative value and each weight has a positive value, and selecting the optimal path based on the path scores comprises:
selecting a path having a minimum path score.

15. The non-transitory computer readable storage medium of claim 13, wherein a weight of an edge connecting an originating node to a terminating node comprises a difference between a score of the terminating node and a cost of transitioning from the originating node to the terminating node.

16. The non-transitory computer readable storage medium of claim 11, wherein selecting the set of key frames based on the optimal path comprises:
identifying a node in the optimal path having a maximum score; and
selecting a frame corresponding to the identified node as an initial key frame for the set of key frames.

17. The non-transitory computer readable storage medium of claim 16, wherein selecting the set of key frames based on the optimal path comprises:
traversing the optimal path from the identified node corresponding to the initial key frame to an additional node corresponding to a frame satisfying one or more selection criteria; and
selecting the frame satisfying the one or more selection criteria for the set of key frames.

18. The non-transitory computer readable storage medium of claim 11, wherein obtaining video of an event from an image capture device comprises:
continuously recording video of the event from the image capture device;
storing a time interval of the recorded video to a storage device;
receiving a request to generate the clip; and
retrieving a subset of the video within a specific duration of a time when the request was received.

19. The non-transitory computer readable storage medium of claim 18, wherein obtaining video of an event from an image capture device further comprises:
overwriting the time interval of the recorded video stored by the storage device with subsequently recorded video.

20. The non-transitory computer readable storage medium of claim 11, wherein obtaining video of an event from an image capture device comprises:
continuously recording video of the event from the image capture device;
storing a time interval of the recorded video to a storage device;
receiving a request to generate the clip;
retrieving a subset of the video within a specific duration of a time when the request was received; and
retrieving video captured by one or more additional image capture devices captured within the specific duration of the time when the request was received.
